(19) United States
(12) Patent Application Publication
(10) Pub. No.: US 2023/0229918 A1
(43) Pub. Date: Jul. 20, 2023

(54) Method and Apparatus for Continuous Learning of Object Anomaly Detection and State Classification Model

(71) Applicant: SK Planet Co., Ltd., Seongnam-si (KR)

(72) Inventor: Yeong hyeon Park, Cheonan-si (KR)

(21) Appl. No.: 18/186,101

(22) Filed: Mar. 17, 2023

Related U.S. Application Data
(63) Continuation of application No. PCT/KR2021/009040, filed on Jul. 14, 2021.

(30) Foreign Application Priority Data
Mar. 26, 2021 (KR) 10-2021-0039511

(51) Int. Cl. G06N 3/08; G06N 3/0455

(52) U.S. Cl. CPC G06N 3/08; G06N 3/0455

(57) ABSTRACT

According to the present invention, a method for continuous learning of object anomaly detection and state classification model includes acquiring, by a detection and classification apparatus, information about a medium of anomaly detection from an inspection target; generating, by the detection and classification apparatus, an input value, which is a feature vector matrix including a plurality of feature vectors, from the medium information; deriving, by the detection and classification apparatus, a restored value imitating the input value through a detection network learned to generates the restored value for the input value; determining, by the detection and classification apparatus, whether a restoration error indicating a difference between the input value and the restored value is greater than or equal to a previously calculated reference value; and storing, by the detection and classification apparatus, the input value as normal data upon determining that the restoration error is less than the reference value.

### CROSS-REFERENCE TO RELATED APPLICATIONS

This is a bypass continuation of International PCT Application No. PCT/KR2021/009040, filed on Jul. 14, 2021, which claims priority to Republic of Korea Patent Application No. 10-2021-0039511, filed on Mar. 26, 2021, which are incorporated by reference herein in their entirety.

### TECHNICAL FIELD

The present invention relates to a technique for continuous learning of a neural network model, and more particularly, to a method and apparatus for continuous learning of object anomaly detection and state classification model.

### BACKGROUND ART

A typical anomaly detection or state analysis method learns data of a normal category for a specific environment and, when data outside the normal category is inputted, detects and analyzes anomalies. This method properly performs anomaly detection or state classification, after learning once, in a situation where the environment does not change significantly, but if the environment changes, this method may cause an error in misjudging the normal category data of the changed environment as an anomaly.

### SUMMARY

The present invention is intended to provide a method and apparatus for continuous learning of object anomaly detection and state classification model.

According to embodiments of the present invention, a method for continuous learning may include acquiring, by a detection and classification apparatus, information about a medium of anomaly detection from an inspection target; generating, by the detection and classification apparatus, an input value, which is a feature vector matrix including a plurality of feature vectors, from the medium information; deriving, by the detection and classification apparatus, a restored value imitating the input value through a detection network learned to generates the restored value for the input value; determining, by the detection and classification apparatus, whether a restoration error indicating a difference between the input value and the restored value is greater than or equal to a previously calculated reference value; and storing, by the detection and classification apparatus, the input value as normal data upon determining that the restoration error is less than the reference value.

The method may further include, when deriving the restored value, calculating, by the detection and classification apparatus, a classification value indicating a probability that the input value belongs to a category of an anomaly state through a classification network learned to calculate the probability for the input value.

The method may further include, after determining whether the restoration error is greater than or equal to the reference value, determining, by the detection and classification apparatus, whether the classification value is greater than or equal to a predetermined threshold, upon determining that the restoration error is greater than or equal to the reference value; and storing, by the detection and classification apparatus, the input value as category data upon determining that the classification value is greater than or equal to the predetermined threshold.

The method may further include detecting, by the detection and classification apparatus, occurrence of an event requiring a model update; and upon detecting the occurrence of the event, by the detection and classification apparatus, learning the detection network using the stored normal data when normal data of a first predetermined number or more are stored, or learning the classification network using the stored category data when category data of a second predetermined number or more are stored.

The learning may include initializing, by the detection and classification apparatus, the detection network; inputting, by the detection and classification apparatus, the stored normal data as a training input value to the initialized detection network; calculating, by the detection and classification apparatus, an uncompressed latent value from the training input value; calculating, by the detection and classification apparatus, the restored value from the latent value; calculating, by the detection and classification apparatus, a loss that is a difference between the restored value and the training input value; and performing, by the detection and classification apparatus, optimization of updating a parameter of the detection network to minimize the loss.

The method may further include, after the learning, calculating, by the detection and classification apparatus, the reference value in accordance with Equation θ=µ+(k×σ), wherein µ denotes an average of a mean squared error (MSE) between a plurality of training input values and a plurality of restored values corresponding to the plurality of training input values used for learning on the detection network, wherein σ denotes a standard deviation of the MSE between the plurality of training input values and the plurality of restored values corresponding to the plurality of training input values, and wherein k is a weight for the standard deviation.

The learning may include initializing, by the detection and classification apparatus, the classification network; preparing, by the detection and classification apparatus, a training input value by setting a label corresponding to a category of the stored category data; inputting, by the detection and classification apparatus, the training input value to the initialized classification network; calculating, by the detection and classification apparatus, a classification value from the training input value by performing an operation in which a plurality of inter-layer weights are applied; calculating, by the detection and classification apparatus, a classification loss that is a difference between the classification value and the label; and performing, by the detection and classification apparatus, optimization of updating a parameter of the classification network to minimize the classification loss.

According to embodiments of the present invention, an apparatus for continuous learning may include a data processing unit configured to generate an input value, which is a feature vector matrix including a plurality of feature vectors, from information about a medium of anomaly detection from an inspection target; and a detection unit configured to derive a restored value imitating the input value through a detection network learned to generates the restored value for the input value, to determine whether a restoration error indicating a difference between the input value and the restored value is greater than or equal to a previously calculated reference value, and to store the input value as normal data upon determining that the restoration error is less than the reference value.

The detection unit may be configured to calculate a classification value indicating a probability that the input value belongs to a category of an anomaly state through a classification network learned to calculate the probability for the input value.

The detection unit may be configured to determine whether the classification value is greater than or equal to a predetermined threshold, upon determining that the restoration error is greater than or equal to the reference value, and to store the input value as category data upon determining that the classification value is greater than or equal to the predetermined threshold.

The apparatus may further include a learning unit configured to detect occurrence of an event requiring a model update, and to, upon detecting the occurrence of the event, learn the detection network using the stored normal data when normal data of a first predetermined number or more are stored, or learn the classification network using the stored category data when category data of a second predetermined number or more are stored.

The learning unit may be configured to initialize the detection network, and input the stored normal data as a training input value to the initialized detection network, when an encoder of the detection network calculates an uncompressed latent value from the training input value, and calculates the restored value from the latent value, to calculate a loss that is a difference between the restored value and the training input value, and perform optimization of updating a parameter of the detection network to minimize the loss.

The learning unit may be configured to calculate the reference value in accordance with Equation θ=µ+(k×σ), wherein µ denotes an average of a mean squared error (MSE) between a plurality of training input values and a plurality of restored values corresponding to the plurality of training input values used for learning on the detection network, wherein σ denotes a standard deviation of the MSE between the plurality of training input values and the plurality of restored values corresponding to the plurality of training input values, and wherein k is a weight for the standard deviation.

The learning unit may be configured to initialize the classification network, prepare a training input value by setting a label corresponding to a category of the stored category data, and input the training input value to the initialized classification network, when the classification network calculates a classification value from the training input value by performing an operation in which a plurality of inter-layer weights are applied, to calculate a classification loss that is a difference between the classification value and the label, and perform optimization of updating a parameter of the classification network to minimize the classification loss.

According to the present invention, by continuously collecting learning data and updating a model, it is possible to adaptively detect a state anomaly even when the environment changes.

### BRIEF DESCRIPTION OF DRAWINGS

FIG. 1 is a block diagram illustrating the configuration of an apparatus for object anomaly detection and state classification according to an embodiment of the present invention.

FIG. 2 is a block diagram illustrating the detailed configuration of an apparatus for object anomaly detection and state classification according to an embodiment of the present invention.

FIG. 3 is a diagram illustrating the configuration of a detection network according to an embodiment of the present invention.

FIG. 4 is a diagram illustrating the configuration of a classification network according to an embodiment of the present invention.

FIG. 5 is a flowchart illustrating a method of generating an input value according to an embodiment of the present invention.

FIG. 6 is a diagram illustrating a method of generating an input value according to an embodiment of the present invention.

FIG. 7 is a flowchart illustrating a learning method for a detection network for object anomaly detection according to an embodiment of the present invention.

FIG. 8 is a flowchart illustrating a learning method for a classification network for state classification according to an embodiment of the present invention.

FIG. 9 is a flowchart illustrating a method for continuous learning of object anomaly detection and state classification model according to an embodiment of the present invention.

FIG. 10 is a flowchart illustrating a method for continuous learning of object anomaly detection and state classification model according to an embodiment of the present invention.

### DETAILED DESCRIPTION

In order to clarify the characteristics and advantages of the technical solution of the present invention, the present invention will be described in detail through specific embodiments of the present invention with reference to the accompanying drawings.

However, in the following description and the accompanying drawings, well known techniques may not be described or illustrated to avoid obscuring the subject matter of the present invention. Through the drawings, the same or similar reference numerals denote corresponding features consistently.

The terms and words used in the following description, drawings and claims are not limited to the bibliographical meanings thereof and are merely used by the inventor to enable a clear and consistent understanding of the invention. Thus, it will be apparent to those skilled in the art that the following description about various embodiments of the present invention is provided for illustration purpose only and not for the purpose of limiting the invention as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present invention. Also, the terms “comprise”, “include”, “have”, and derivatives thereof refer to inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In the description and claims, the term “network” is defined as one or more data links that enable electronic data to be transmitted between computer systems and/or modules. When any information is transferred or provided to a computer system via a network or other (wired, wireless, or a combination thereof) communication connection, this connection can be understood as a computer-readable medium. The computer-readable instructions include, for example, instructions and data that cause a general purpose computer system or special purpose computer system to perform a particular function or group of functions. The computer-executable instructions may be binary, intermediate format instructions, such as, for example, an assembly language, or even source code.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

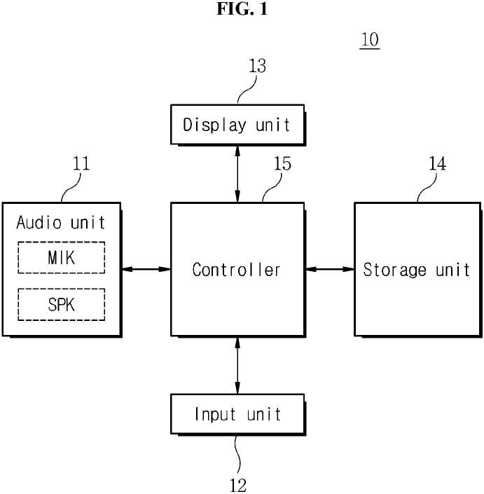

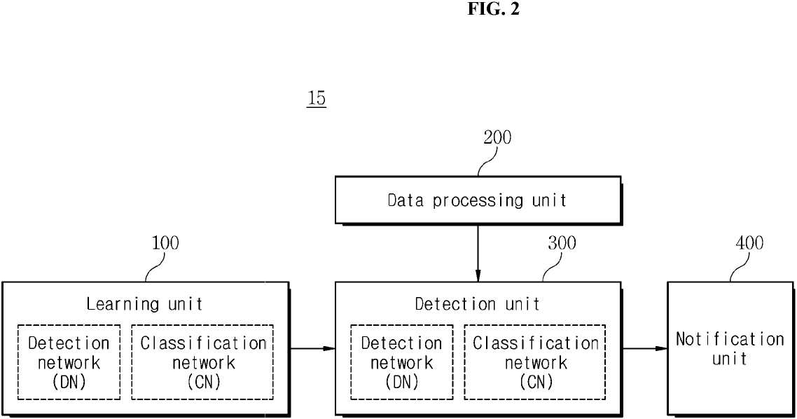

At the outset, an apparatus for object anomaly detection and state classification according to an embodiment of the present invention will be described. FIG. 1 is a block diagram illustrating the configuration of an apparatus for object anomaly detection and state classification according to an embodiment of the present invention. FIG. 2 is a block diagram illustrating the detailed configuration of an apparatus for object anomaly detection and state classification according to an embodiment of the present invention. Referring to FIG. 1, an apparatus for object anomaly detection and state classification 10 (hereinafter, abbreviated as a detection and classification apparatus) according to an embodiment of the present invention includes an audio unit 11, an input unit 12, a display unit 13, a storage unit 14, and a controller 15.

The audio unit 11 includes a microphone MIK for collecting an audio signal, such as a sound, which is a medium of anomaly detection according to an embodiment of the present invention. That is, the audio unit 11 transmits a sound inputted through the microphone MIK, for example, an audio signal such as noise, to the controller 15. Also, the audio unit 11 further includes a speaker SPK for outputting an audio signal. The audio unit 11 may output an audio signal through the speaker SPK under the control of the controller 15. Meanwhile, although in the drawings the detection and classification apparatus 10 is shown as including only the audio unit 11, the detection and classification apparatus 10 may also include a measurement unit (not shown) having various sensors as well as the audio unit 11. That is, the detection and classification apparatus 10 may include various sensors such as an image sensor and a fine dust sensor, and a medium for detecting an anomaly from an inspection target may be expanded to images, fine dust, and the like, without being limited to noise.

The input unit 12 receives a user’s key manipulation for controlling the detection and classification apparatus 10, generates an input signal, and transmits the generated input signal to the controller 15. The input unit 12 may include at least one of a power on/off key, a numeral key, and a direction key, and may be formed as a predetermined function key on one side of the detection and classification apparatus 10. When the display unit 13 is made of a touch screen, the functions of various keys of the input unit 12 may be performed on the display unit 13. If all of such functions can be performed only with the touch screen, the input unit 12 may be omitted.

The display unit 13 visually provides a user with a menu of the detection and classification apparatus 10, input data, function setting information, and other various kinds of information. The display unit 13 outputs various screens such as a booting screen, an idle screen, and a menu screen of the detection and classification apparatus 10. The display unit 13 may be formed of a liquid crystal display (LCD), an organic light emitting diode (OLED), an active matrix organic light emitting diode (AMOLED), or the like. Meanwhile, the display unit 13 may be implemented as a touch screen. In this case, the display unit 13 may include a touch sensor, and the controller 15 may sense a user’s touch input through the touch sensor. The touch sensor may be formed of a touch sensing sensor of a capacitive overlay type, a pressure type, a resistive overlay type, or an infrared beam type, or may be formed of a pressure sensor. In addition to the above sensors, all kinds of sensor devices capable of sensing contact or pressure of an object may be used as the touch sensor of the present invention. The touch sensor senses a user’s touch input, generates a sensing signal, and transmits it to the controller 15. The sensing signal may include coordinate data of a user’s touch input. When the user inputs a touch position movement motion, the touch sensor may generate a sensing signal including coordinate data of a touch position movement path and transmit it to the controller 15.

The storage unit 14 stores programs and data necessary for the operation of the detection and classification apparatus 10, and may be divided into a program area and a data area. The program area may store a program for controlling the overall operation of the detection and classification apparatus 10, an operating system (OS) for booting the detection and classification apparatus 10, an application program, and the like. The data area may store data generated in response to the use of the detection and classification apparatus 10. Also, the storage unit 14 may store various types of data generated in response to the operation of the detection and classification apparatus 10.

The controller 15 may control the overall operation of the detection and classification apparatus 10 and the signal flow between internal blocks of the detection and classification apparatus 10, and perform a data processing function. The controller 15 may be a central processing unit (CPU), an application processing unit (APU), an accelerated processing unit (APU), a graphic processing unit (GPU), a neural processing unit (NPU), or the like.

Referring to FIG. 2, the controller 15 includes a learning unit 100, a data processing unit 200, a detection unit 300, and a notification unit 400.

The learning unit 100 is configured to perform learning (deep learning) on a detection network DN and a classification network CN, which are deep learning models DLM according to an embodiment of the present invention. The detection network DN and the classification network CN that complete learning are transferred to the detection unit 300 and executed in the detection unit 300.

The data processing unit 200 generates, from noise received from the audio unit 11, an input value that is a feature vector matrix including a plurality of feature vectors. The generated input value is inputted to the detection unit 300. Here, if there is a measurement unit in addition to the audio unit 11, the data processing unit 200 may generate an input value, which is a feature vector matrix, by using information about a medium for anomaly detection received from the measurement unit.

The detection unit 300 is configured to analyze the noise converted into the input value through the learning-completed detection network DN and thereby detect an anomaly or not in an inspection target that emits the noise. In particular, the detection unit 300 may analyze the input value and classify it into normal data representing a normal state or category data belonging to the category of an anomaly state and store such data in the storage unit 14 such that it can be used as an input value for learning upon a model update according to environmental changes.

When the detection unit 300 detects an anomaly in the inspection target, the notification unit 400 outputs a warning sound through the speaker SPK of the audio unit 11 and outputs a warning message through the display unit 13.

The operation of the controller 13 including the learning unit 100, the data processing unit 200, the detection unit 300, and the notification unit 400 will be described in more detail below.

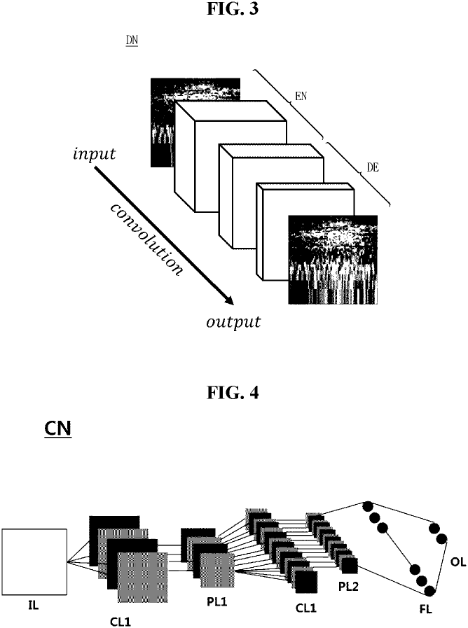

Next, the configuration of a detection network (DN) according to an embodiment of the present invention will be described. FIG. 3 is a diagram illustrating the configuration of a detection network according to an embodiment of the present invention. Referring to FIG. 3, the detection network DN includes an encoder EN and a decoder DE.

The detection network DN including the encoder EN and the decoder DE includes a plurality of layers, which include a plurality of operations. In addition, the plurality of layers are connected by a weight. A calculation result of one layer is weighted and then becomes an input of a node of the next layer. That is, one layer of the detection network DN receives a weighted value from the previous layer, performs an operation on it, and transfers the operation result to the input of the next layer.

When an input value (x) is inputted, the encoder EN performs a plurality of operations in which a plurality of inter-layer weights are applied to the input value (x) without dimension reduction, thereby computing and outputting a latent value (z) that is a latent vector. The decoder DE performs a plurality of operations in which a plurality of inter-layer weights are applied to the latent value (z) without dimensional expansion, thereby generating a restored value (x′). That is, the input value is a feature vector matrix including a plurality of feature vectors, and is two-dimensional data (the number of elements of the feature vector X the number of feature vectors). If a layer such as a fully connected layer is used, the dimension may be reduced from 2D to 1D. However, the present invention generates the latent value (z) and the restored value (x′) from the input value (x) without such dimension reduction.

The encoder EN includes an enlarge layer (EL) and at least one convolution layer (CL). A pooling layer (PL) may be further included between the convolutional layers of the encoder EN. The decoder DE includes at least one convolution layer (CL). A pooling layer (PL) may be further included between the convolutional layers of the decoder DE.

The enlarge layer generates a feature map with a size enlarged than the input value in order to perform an operation on the input value (x) without dimension reduction. The convolution layer generates a feature map by performing a convolution operation and an operation by an activation function. The pooling layer generates a feature map by performing a max pooling operation.

The feature map generated by the last layer of the encoder EN is the latent value (z), and the feature map generated by the last layer of the decoder DE is the restored value (x′).

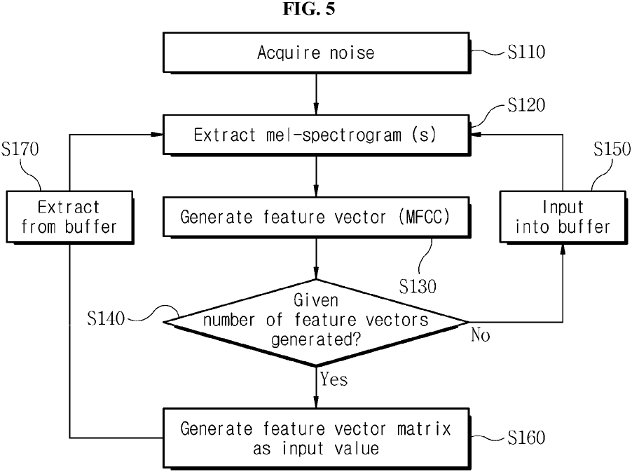

Next, the configuration of a classification network (CN) according to an embodiment of the present invention will be described. FIG. 4 is a diagram illustrating the configuration of a classification network according to an embodiment of the present invention.

Referring to FIG. 4, the classification network CN may include an input layer (IL), at least one pair of a convolution layer (CL) and a pooling layer (PL), which are alternately repeated, at least one fully-connected layer (FL), and an output layer (OL). As shown in FIG. 4, the classification network CN according to an embodiment of the present invention sequentially includes an input layer IL, a first convolution layer CL1, a first pooling layer PL1, a second convolution layer CL2, a second pooling layer PL2, a fully-connected layer FL, and an output layer OL.

The convolution layers CL1 and CL2 and the pooling layers PL1 and PL2 are composed of at least one feature map (FM). The feature map (FM) is derived as a result of receiving an input value obtained by applying a weight (w) to the operation result of the previous layer and performing an operation on the input value. This weight (w) may be applied through a filter or kernel (w), which is a weight matrix of a predetermined size.

When an input value (a matrix or a row vector of a predetermined size) is inputted to the input layer IL, the first convolution layer CL1 performs a convolution operation using a filter or kernel (w) and an operation by an activation function on the input value of the input layer IL and derives at least one first feature map (FM1). Subsequently, the first pooling layer PL1 performs a pooling or sub-sampling operation using a filter or kernel (w) on the at least one first feature map (FM1) of the convolution layer CL and derives at least one second feature map (FM2). Subsequently, the second convolution layer CL2 performs a convolution operation using a filter or kernel (w) and an operation by an activation function on the second feature map (FM2) and derives at least one third feature map (FM3). Subsequently, the second pooling layer PL2 performs a pooling or sub-sampling operation using a filter or kernel (w) on the at least one third feature map (FM3) of the second convolution layer CL2 and derives at least one fourth feature map (FM4).

The fully-connected layer FL is composed of a plurality of operation nodes. The plurality of operation nodes of the fully-connected layer FL calculate a plurality of operation values through an operation by an activation function on the at least one fourth feature map (FM4) of the second pooling layer PL2.

The output layer OL includes one or more output nodes. Each of the plurality of operation nodes (f1 to fx) of the fully-connected layer FL is a channel having a weight (w) and is connected to an output node of the output layer OL. In other words, the plurality of operation values of the plurality of operation nodes are inputted to the output node after a weight is applied. Accordingly, the output node of the output layer OL calculates a classification value through an operation by an activation function for the plurality of operation values to which the weight of the fully-connected layer FL is applied. The classification value represents the probability that the input value is data belonging to the category corresponding to the output node.

The activation function used in the convolution layer CL, the fully-connected layer FL, and the output layer OL described above may be sigmoid, hyperbolic tangent (tanh), exponential linear unit (ELU), rectified linear unit (ReLU), leakly ReLU, Maxout, Minout, Softmax, or the like. Any one of these activation functions may be selected and applied to the convolution layer CL, the fully-connected layer FL, and the output layer OL.

In summary, as described above, the classification network CN includes a plurality of layers. In addition, the plurality of layers of the classification network CN include a plurality of operations. The operation result of each of the plurality of layers is transferred to the next layer after a weight is applied. Accordingly, the classification network CN may calculate a classification value by performing the plurality of operations, to which the weights of the plurality of layers are applied, on the input value and output the calculated classification value.

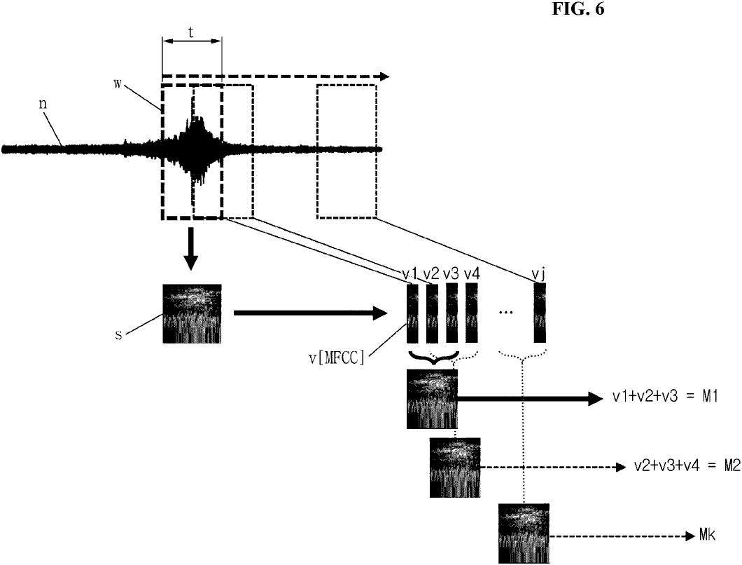

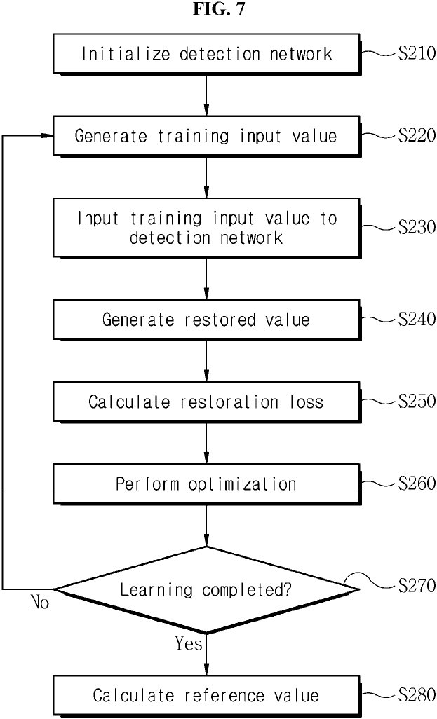

Next, an input value according to an embodiment of the present invention is an audio signal such as noise. This input value may be, but is not limited to, an audio signal itself or a signal obtained by detecting features in the audio signal. Then, a method of generating an input value will be described exemplarily. FIG. 5 is a flowchart illustrating a method of generating an input value according to an embodiment of the present invention. FIG. 6 is a diagram illustrating a method of generating an input value according to an embodiment of the present invention.

Referring to FIGS. 5 and 6, at step S110, the audio unit 11 acquires a noise generated from an inspection target through the microphone MIC and provides it to the data processing unit 200 of the controller 15. Here, the noise generated from the inspection target may be, for example, a noise generated from an engine of a vehicle, a noise generated by friction between wheels of a vehicle and a road surface while the vehicle is running, a noise generated from a production facility in a factory, a noise generated from a home appliance such as a noise generated from the rear of a refrigerator, or the like.

At step S120, the data processing unit 200 applies a sliding window (w) having a predetermined time length (t) (e.g., 20-40 ms) to the noise (n) continuously inputted through the audio unit 11, and extracts a mel-spectrogram (s) indicating the intensity and frequency distribution of the noise (n) according to the mel-scale in units of the sliding window (w).

Then, at step S130, the data processing unit 200 calculates a time average for the extracted mel-spectrogram (s), and generates a feature vector (v) by compressing the mel-spectrogram (s) with mel-frequency cepstral coefficient (MFCC).

At step S140, the data processing unit 200 determines whether a predetermined number of feature vectors (v) are generated to form a feature vector matrix. For example, it is assumed that the feature vector matrix consists of three feature vectors (v).

If it is determined at the step S140 that the predetermined number of feature vectors (v) are not generated, the data processing unit 200 proceeds to step S150 and inputs the generated feature vector (v) into a buffer. Here, the buffer has the same size as the number (e.g., three) of the feature vectors (v) constituting the feature vector matrix. The buffer is a queue-type buffer, and the first inputted feature vector (v) is extracted first.

On the other hand, if it is determined at the step S140 that the predetermined number of feature vectors (v) are generated, the data processing unit 200 proceeds to step S160 and generates a feature vector matrix (M) by combining the predetermined number of generated feature vectors (v) in a matrix form. For example, as shown in FIG. 6, a first feature vector matrix (M1) is generated by sequentially combining three feature vectors, that is, first, second, and third feature vectors (v1, v2, and v3).

Next, at step S170, the data processing unit 200 extracts the first inputted feature vector from the buffer. For example, if the first feature vector matrix (M1) is generated by sequentially combining three feature vectors (v1, v2, and v3), the first feature vector (v1) is extracted.

Then, the above-described steps S120 to S160 are repeated. Accordingly, for example, as shown in FIG. 6, a new feature vector, that is, a fourth feature vector (v4) is generated, and a second feature vector matrix (M2) is generated by combining three feature vectors, that is, the second, third, and fourth feature vectors (v2, v3, and v4).

The data processing unit 200 may provide the feature vector matrix (M) generated by the method described above to the detection unit 300 as an input value (x).

Next, learning methods for a detection network DN and a classification network CN according to an embodiment of the present invention will be described. First, a learning method for a detection network DN according to an embodiment of the present invention will be described. FIG. 7 is a flowchart illustrating a learning method for a detection network for object anomaly detection according to an embodiment of the present invention.

Referring to FIG. 7, at step S210, the learning unit 100 initializes a detection network (DN). At this time, the learning unit 100 initializes a parameter of the detection network (DN), that is, a weight (w). For initialization, the Xavier initializer may be used.

When the initialization is completed, the learning unit 100 prepares at step S220 an input value (x) used for training, that is, a training input value (x), to the initialized detection network (DN). In an embodiment of the present invention, the training input value (x) used initially refers to a feature vector matrix generated from noise (n) generated by an inspection target when the inspection target is normal. The training input value (x) is generated in the same method as the input value (x) previously described with reference to FIGS. 5 and 6. In particular, at the step S220, normal data stored in the storage unit 14 is used as the training input value (x) when the detection network (DN) is updated depending on a change in an environment. A method of storing such normal data will be described in detail below.

Next, at step S230, the learning unit 100 inputs the training input value (x) to the initialized detection network (DN). Then, at step S240, the detection network (DN) generates a restored value (x′) imitating the training input value (x) by performing a plurality of operations in which a plurality of inter-layer weights are applied. In more detail, the encoder (EN) of the detection network (DN) performs a plurality of operations in which a plurality of inter-layer weights are applied to the training input value (x), and thereby calculates a latent value (z) for the training input value (x) without dimension reduction. In addition, the decoder (DE) of the detection network (DN) performs a plurality of operations in which a plurality of inter-layer weights are applied to the latent value (z) calculated by the encoder (EN), and thereby calculates the restored value (x′) without dimensional expansion.

Then, at step S250, the learning unit 100 calculates a restoration loss according to the following Equation 1.

$$L d = \left|x - D \left(E \left(x\right)\right)\right| = \left|x - {x}^{′}\right|$$

In Equation 1, E( ) represents the operation of the encoder (EN), and D( ) represents the operation of the decoder (DE). Also, Ld in Equation 1 represents a restoration loss. The restoration loss Ld represents a difference between the training input value (x) and the restored value (x′).

Next, at step S260, the learning unit 100 performs optimization of updating the weight (w) of the detection network (DN) through a back-propagation algorithm in order to minimize the restoration loss.

The above-described steps S220 to S260 may be repeatedly performed until the restoration loss calculated using a plurality of different training input values (x) is less than or equal to a predetermined target value. To this end, at step S270, the learning unit 100 determines whether the learning is completed by determining whether the restoration loss is less than or equal to a predetermined target value. That is, when the restoration loss is less than or equal to a predetermined target value, the learning unit 100 determines that learning has been sufficiently made, and thereby determines that learning is completed.

When learning is completed, the learning unit 100 calculates at step S280 a reference value of the restoration loss which is a difference between the input value (x) and the restored value (x′). This reference value is calculated according to Equation 2 below.

$$\text{θ} = \text{μ} + \left(\text{k} \times \text{σ}\right)$$

In Equation 2, θ represents a reference value. In Equation 2, µ and σ respectively denote the average and standard deviation of the mean squared error (MSE) between a plurality of training input values (x) and a plurality of restored values (x′) corresponding to the plurality of training input values (x) used in a learning procedure, namely, used for learning on the detection network (DN). In addition, k is a weight for the standard deviation σ, and 1.5 to 3 may be applied. Therefore, when the learning is completed, the learning unit 100 calculates the reference value θ and stores it in the storage unit 14.

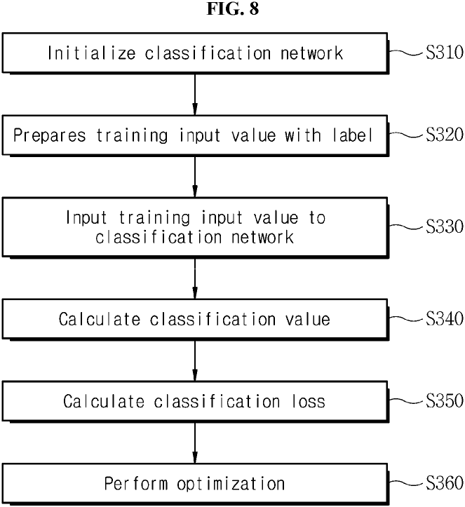

Next, a learning method for a classification network CN according to an embodiment of the present invention will be described. FIG. 8 is a flowchart illustrating a learning method for a classification network for state classification according to an embodiment of the present invention.

Referring to FIG. 8, at step S310, the learning unit 100 initializes a classification network (CN). At this time, the learning unit 100 initializes a parameter of the classification network (CN), that is, a weight (w). For initialization, the Xavier initializer may be used.

Then, at step S320, the learning unit 100 prepares a training input value where a label is set. The training input value is a feature vector matrix generated from the noise (n) occurring in an inspection target, and its category has been known. Here, it is preferable that the corresponding category is an anomaly state. That is, the training input value for the classification network (CN) is a feature vector matrix generated from the noise (n) occurring in the inspection target in an anomaly state, and may be a value set with a label corresponding to the category, for example, an anomaly state. In particular, at the step S320, the training input values used when the classification network (CN) is updated according to changes in the environment may be category data stored in the storage unit 14. A method of storing such category data will be described in detail below.

Next, at step S330, the learning unit 100 enters the training input value to the classification network (CN) initialized. Then, at step S340, the classification network (CN) calculates a classification value by performing a plurality of operations in which a plurality of inter-layer weights are applied to the training input value. The classification value includes the probability that the training input value belongs to the category in the anomaly state. Subsequently, at step S350, the learning unit 100 calculates a classification loss through a loss function such as Equation 3 below.

$$L c = {\sum }_{i = 1}^{n} {\left({y}_{i} - f \left({x}_{i}\right)\right)}^{2}$$

In Equation 3, ‘Lc’ denotes a loss (L2 Loss), and ‘i’ is an index corresponding to training data. Also, ‘f(xᵢ)’ denotes an output value calculated by the classification network (CN) from an input value (xᵢ), and ‘yᵢ’ denotes a label representing an expected value. That is, ‘yᵢ’ is a label corresponding to the i-th training input value (xᵢ). In addition, ‘f(xᵢ)’ is an output value calculated by the classification network (CN) for the i-th training input value (xᵢ).

Then, at step S360, the learning unit 200 performs optimization of correcting the weight (w) of a machine learning model (MLM) so that the loss, which is a difference between the output value and the label of the classification network (CN) machine learning model (MLM). For this optimization, a back-propagation algorithm may be used. The aforementioned steps S320 to S360 are repeatedly performed using a plurality of different training input values. This repetition may be performed until accuracy is calculated through an evaluation index and desired accuracy is reached.

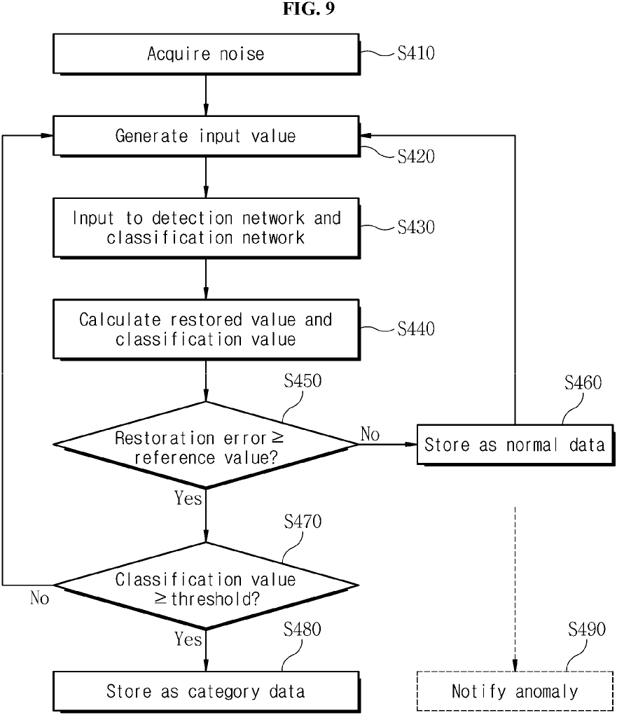

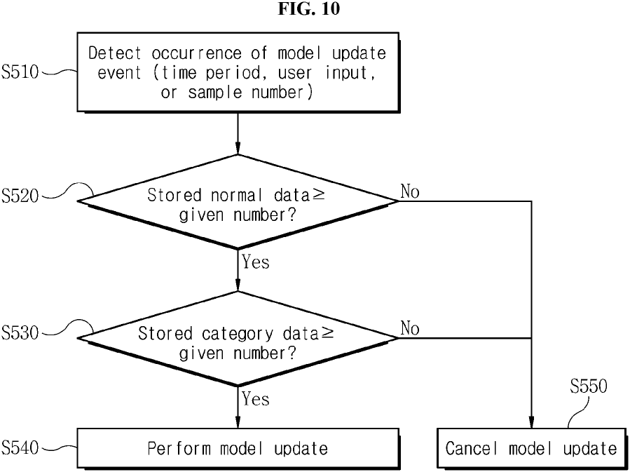

When the learning on the detection network (DN) and the classification network (CN) is completed in accordance with the above-described procedure, it is possible to detect an anomaly by using the detection network (DN) and the classification network (CN). This method will be described. FIG. 9 is a flowchart illustrating a method for continuous learning of object anomaly detection and state classification model according to an embodiment of the present invention.

Referring to FIG. 9, at step S410, the audio unit 11 continuously acquires a noise generated from an inspection target through the microphone MIC and provides it to the data processing unit 200 of the controller 15. Then, at step S420, the data processing unit 200 generates an input value (x) from the acquired noise (n). For example, as described with reference to FIGS. 5 and 6, the data processing unit 200 sequentially extracts a plurality of mel-spectrograms (s) from the noise (n) in units of the sliding window (w), and generates a plurality of feature vectors (v: v1, v2, v3, v4, ... vj) by compressing the extracted mel-spectrograms (s) with MFCC. Then, the data processing unit 200 forms a feature vector matrix by combining a predetermined number of feature vectors (v) and thereby generates an input value (x).

At step S430, the detection unit 300 inputs the input value (x) to the detection network (DN). Then, at step S440, the detection network (DN) of the detection unit 300 generates a restored value (x′) imitating the input value (x) through a plurality of operations in which a plurality of inter-layer weights are applied to the input value (x). That is, the encoder (EN) calculates a latent value (z) from the input value (x) without dimension reduction by performing a plurality of operations in which a plurality of inter-layer weights are applied to the input value (x), and the decoder (DE) calculates a restored value (x′) from the latent value (z) without dimensional expansion by performing a plurality of operations in which a plurality of inter-layer weights are applied. Further, at the same time as calculating the restored value, at the step S440, the classification network (CN) of the detection unit 300 may calculate a classification value f(xᵢ) by performing a plurality of operations in which a plurality of inter-layer weights are applied to the input value (xᵢ).

At step S450, the detection unit 300 determines whether a restoration error, which indicates a difference between the input value (x) and the restored value (x′) as shown in Equation 4 below, is greater than or equal to a reference value (θ) determined according to Equation 2 above.

$$\left‖\text{x} - {\text{x}}^{′}\right‖ \geq \text{θ}$$

In Equation 4, θ represents a reference value. Also, x denotes an input value and x′ denotes a restored value.

If it is determined at the step S450 that the restoration error is less than the reference value (0), the detection unit 300 proceeds to step S460, determines that the input value (x) is normal data that is data in a normal state, and stores the input value (x) as normal data. This means that a label indicating a normal state is given to the input value (x) and stored.

Otherwise, if it is determined at the step S450 that the restoration error is greater than or equal to the reference value (0), the detection unit 300 determines that there is an anomaly in the inspection target, and determines at step S470 whether the classification value is equal to or greater than a predetermined threshold.

If it is determined at the step S470 that the classification value is greater than or equal to threshold, the detection unit 300 determines at step S480 that the input value is category data, and stores the input value (x) as category data belonging to the category of anomaly state. This means that a label indicating an anomaly state is given to the input value (x) and stored.

In addition, as the detection unit 300 determines that there is an anomaly in the inspection target, the notification unit 400 notifies the detected anomaly state at step S490 by outputting a warning sound through the audio unit 11 and outputting a warning message through the display unit 13.

As described above, the stored normal data and category data can be used as training input values. Accordingly, the present invention can continuously learn the detection network (DN) and the classification network (CN) by using the training input values stored by the anomaly detection process as shown in FIG. 9. This method will be described. FIG. 10 is a flowchart illustrating a method for continuous learning of object anomaly detection and state classification model according to an embodiment of the present invention.

Referring to FIG. 10, at step S510, the learning unit 100 may detect the occurrence of an event requiring a model update. This event refers to the arrival of an update period, a user’s specific input, or a state in which training input values of a predetermined number or more are accumulated and stored.

Upon detecting the event, the learning unit 100 determines at step S520 whether normal data equal to or greater than a first predetermined number are stored, and further determines at step S530 whether category data equal to or greater than a second predetermined number are stored.

If normal data of the first predetermined number or more are stored and if category data of the second predetermined number or more are stored, the learning unit 100 may update, at step S540, the model by learning the detection network (DN) and the classification network (CN) using the stored normal data and the stored category data.

On the other hand, if normal data of the first predetermined number or more are not stored or if category data of the second predetermined number or more are not stored, the learning unit 100 may cancel the model update at step S550.

Meanwhile, in the above-described embodiment referring to FIG. 10, the detection network (DN) and the classification network (CN) are updated together. However, according to an alternative embodiment of the present invention, when normal data of the first predetermined number or more are stored, the learning unit 100 may individually update the model by individually learning the detection network (DN) using the stored normal data. In addition, when category data of the second predetermined number or more are stored, the learning unit 100 may individually update the model by individually learning the classification network (CN) using the stored category data.

According to the present invention, since the model is periodically updated in response to a changing environment, it is possible to automatically or semi-automatically adapt and respond to environmental changes. Moreover, the cost of collecting training data is reduced because data is automatically collected and labeled depending on environmental changes.

The method according to an embodiment of the present invention may be provided in the form of a non-transitory computer-readable recording medium suitable for storing computer program instructions and data. The computer-readable recording medium may include program instructions, data files, data structures, etc. alone or in combination, and includes all kinds of recording devices in which data that can be read by a computer system is stored. The computer-readable recording medium includes a hardware device specially configured to store and execute program instructions, including magnetic media such as a hard disk, a floppy disk, and a magnetic tape, optical media such as a compact disc read only memory (CD-ROM) and a digital versatile disc (DVD), magneto-optical media such as a floptical disk, and semiconductor memories such as a read only memory (ROM), a random access memory (RAM), and a flash memory. Further, the computer-readable recording medium may be distributed over networked computer systems so that computer-readable code can be stored and executed in a distributed fashion. In addition, functional programs, associated codes, and code segments for implementing the present invention easily deduced or altered by programmers in the art to which the present invention belongs.

While the specification contains many specific implementation details, these should not be construed as limitations on the scope of the present invention or of what may be claimed, but rather as descriptions of features that may be specific to particular embodiments of particular invention. Certain features that are described in the specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although operations are illustrated as being performed in a predetermined order in the drawings, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

Certain embodiments of the subject matter of the present invention have been described hereinabove. Other embodiments are also within the scope of the following claims. For example, acts recited in the claims may be performed in a different order and still achieve desirable results. As an example, the processes depicted in the accompanying drawings do not necessarily require the specific illustrated order or sequential order to achieve desirable results. In certain implementations, multitasking and parallel processing may be advantageous.

This description shows the best mode of the present invention and provides examples to illustrate the present invention and to enable a person skilled in the art to make and use the present invention. The present invention is not limited by the specific terms used herein. Based on the above-described embodiments, one of ordinary skill in the art can modify, alter, or change the embodiments without departing from the scope of the present invention.

Accordingly, the scope of the present invention should not be limited by the described embodiments and should be defined by the appended claims.

The present invention relates to a method and apparatus for continuous learning of object anomaly detection and state classification model and can detect an anomaly state adaptively to environmental changes by continuously collecting training data and updating a model. Therefore, the present invention has industrial applicability because it is not only sufficiently commercially available or commercially viable, but also to the extent that it can be clearly practiced in reality.

1. A method for continuous learning, the method comprising:
acquiring, by a detection and classification apparatus, information about a medium of anomaly detection from an inspection target;
generating, by the detection and classification apparatus, an input value, which is a feature vector matrix including a plurality of feature vectors, from the medium information;
deriving, by the detection and classification apparatus, a restored value imitating the input value through a detection network learned to generates the restored value for the input value;
determining, by the detection and classification apparatus, whether a restoration error indicating a difference between the input value and the restored value is greater than or equal to a previously calculated reference value; and
storing, by the detection and classification apparatus, the input value as normal data upon determining that the restoration error is less than the reference value.

2. The method of claim 1, further comprising:
when deriving the restored value, calculating, by the detection and classification apparatus, a classification value indicating a probability that the input value belongs to a category of an anomaly state through a classification network learned to calculate the probability for the input value.

3. The method of claim 2, further comprising:
after determining whether the restoration error is greater than or equal to the reference value,
determining, by the detection and classification apparatus, whether the classification value is greater than or equal to a predetermined threshold, upon determining that the restoration error is greater than or equal to the reference value; and
storing, by the detection and classification apparatus, the input value as category data upon determining that the classification value is greater than or equal to the predetermined threshold.

4. The method of claim 3, further comprising:
detecting, by the detection and classification apparatus, occurrence of an event requiring a model update; and
upon detecting the occurrence of the event, by the detection and classification apparatus, learning the detection network using the stored normal data when normal data of a first predetermined number or more are stored, or learning the classification network using the stored category data when category data of a second predetermined number or more are stored.

5. The method of claim 4, wherein the learning includes:
initializing, by the detection and classification apparatus, the detection network;
inputting, by the detection and classification apparatus, the stored normal data as a training input value to the initialized detection network;
calculating, by the detection and classification apparatus, an uncompressed latent value from the training input value;
calculating, by the detection and classification apparatus, the restored value from the latent value;
calculating, by the detection and classification apparatus, a loss that is a difference between the restored value and the training input value; and
performing, by the detection and classification apparatus, optimization of updating a parameter of the detection network to minimize the loss.

6. The method of claim 5, further comprising:
after the learning, calculating, by the detection and classification apparatus, the reference value in accordance with Equation θ=µ+(k×σ),
wherein µ denotes an average of a mean squared error (MSE) between a plurality of training input values and a plurality of restored values corresponding to the plurality of training input values used for learning on the detection network,
wherein σ denotes a standard deviation of the MSE between the plurality of training input values and the plurality of restored values corresponding to the plurality of training input values, and
wherein k is a weight for the standard deviation.

7. The method of claim 4, wherein the learning includes:
initializing, by the detection and classification apparatus, the classification network;
preparing, by the detection and classification apparatus, a training input value by setting a label corresponding to a category of the stored category data;
inputting, by the detection and classification apparatus, the training input value to the initialized classification network;
calculating, by the detection and classification apparatus, a classification value from the training input value by performing an operation in which a plurality of inter-layer weights are applied;
calculating, by the detection and classification apparatus, a classification loss that is a difference between the classification value and the label; and
performing, by the detection and classification apparatus, optimization of updating a parameter of the classification network to minimize the classification loss.

8. A non-transitory computer-readable recording medium that records a program for executing the method for continuous learning according to claim 1.

9. An apparatus for continuous learning, the apparatus comprising:
a data processing unit configured to generate an input value, which is a feature vector matrix including a plurality of feature vectors, from information about a medium of anomaly detection from an inspection target; and
a detection unit configured to derive a restored value imitating the input value through a detection network learned to generates the restored value for the input value, to determine whether a restoration error indicating a difference between the input value and the restored value is greater than or equal to a previously calculated reference value, and to store the input value as normal data upon determining that the restoration error is less than the reference value.

10. The apparatus of claim 9, wherein the detection unit is configured to calculate a classification value indicating a probability that the input value belongs to a category of an anomaly state through a classification network learned to calculate the probability for the input value.

11. The apparatus of claim 10, wherein the detection unit is configured to determine whether the classification value is greater than or equal to a predetermined threshold, upon determining that the restoration error is greater than or equal to the reference value, and to store the input value as category data upon determining that the classification value is greater than or equal to the predetermined threshold.

12. The apparatus of claim 11, further comprising:
a learning unit configured to:
detect occurrence of an event requiring a model update, and
upon detecting the occurrence of the event, learn the detection network using the stored normal data when normal data of a first predetermined number or more are stored, or learn the classification network using the stored category data when category data of a second predetermined number or more are stored.

13. The apparatus of claim 12, wherein the learning unit is configured to:
initialize the detection network, and input the stored normal data as a training input value to the initialized detection network,
when an encoder of the detection network calculates an uncompressed latent value from the training input value, and calculates the restored value from the latent value,
calculate a loss that is a difference between the restored value and the training input value, and perform optimization of updating a parameter of the detection network to minimize the loss.

14. The apparatus of claim 13, wherein the learning unit is configured to:
calculate the reference value in accordance with Equation θ=µ+(k×σ),
wherein µ denotes an average of a mean squared error (MSE) between a plurality of training input values and a plurality of restored values corresponding to the plurality of training input values used for learning on the detection network,
wherein σ denotes a standard deviation of the MSE between the plurality of training input values and the plurality of restored values corresponding to the plurality of training input values, and
wherein k is a weight for the standard deviation.

15. The apparatus of claim 12, wherein the learning unit is configured to:
initialize the classification network, prepare a training input value by setting a label corresponding to a category of the stored category data, and input the training input value to the initialized classification network,
when the classification network calculates a classification value from the training input value by performing an operation in which a plurality of inter-layer weights are applied,
calculate a classification loss that is a difference between the classification value and the label, and perform optimization of updating a parameter of the classification network to minimize the classification loss.

16. The apparatus of claim 13, wherein the learning unit includes any one of:
an autoencoder model including an encoder and a decoder,
a generative adversarial network including a single encoder, a single decoder, and a single discriminator, and
a generative artificial neural network selectively including a single or a plurality of encoders, decoders, and discriminators.

17. The apparatus of claim 16, wherein the learning unit is configured to:
generate a mean square loss of an input value and a restored value or use a restoration error,
when using the discriminator, use a mean square loss of a discriminator output for an actual input and a generated input as a discrimination error, and
when a user input is entered, set the restoration error and the discrimination error according to the user input.
